(19) United States
(12) Patent Application Publication
(10) Pub. No.: US 2008/0075259 A1
(43) Pub. Date: Mar. 27, 2008

(54) DYNAMIC ADDRESS MAPPING

(75) Inventors: Nicholas Mark Trevallyn-Jones, North Sydney (AU); Meredith Anne Trevallyn-Jones, North Sydney (AU)

Correspondence Address: KNOBBE MARTENS OLSON & BEAR LLP, 2040 MAIN STREET, FOURTEENTH FLOOR, IRVINE, CA, 92614, US

(73) Assignee: ninety9.com Pty. Ltd., North Sydney (AU)

(21) Appl. No.: 11/941,868

(22) Filed: Nov. 16, 2007

Related U.S. Application Data
(63) Continuation of application No. PCT/AU2006/000662, filed on May 18, 2006.

(30) Foreign Application Priority Data
May 18, 2005 (AU) 2005902532

(51) Int. Cl. H04M 3/42

(52) U.S. Cl. 379/211.02

(57) ABSTRACT

To permit communications between devices using different communication protocols, a mapping device is connected to one or more communication networks, and stores associations between communication addresses as dynamic address mappings. A dynamic address mapping is associated with an initiator address (from which the communication is initiated) and a recipient address (to which a communication is initially addressed) and minimally contains a final address (to which a communication is finally routed). A new dynamic address mapping can be created in response a request, typically from a communication initiator. Communications from the initiator address to the recipient address are routed to the final address, with appropriate format conversion if the protocol of the final address is different to that of the initiator address. A reply address may also be stored in a dynamic address mapping for return communications, and a reply mapping may be automatically generated to map the reply address to the initiator address.

### CROSS-REFERENCE TO RELATED APPLICATIONS

This application is a continuation, and claims the benefit under 35 U.S.C. §§ 120 and 365 of PCT Application No. PCT/AU2006/000662, filed on May 18, 2006, which is hereby incorporated in its entirety.

### BACKGROUND OF THE INVENTION

1. Field of the Invention

This invention relates to routing of communications, and is particularly, but not solely, suitable for selective routing of electronic communications between devices which use different communication protocols. The invention provides a method and apparatus enabling a sender or initiator to create a mapping between a protocol-specific address for an intended recipient, and a protocol-specific address compatible with the initiating protocol.

2. Description of the Related Technology

Communication networks such as telephone networks and data networks are used to carry various types of telephonic and data communications. Often, communication networks are interconnected with other communication networks. Various different protocols are used for communication on these networks, each defining how the end-points of the communication are described and located (as well as the form the communication must take so that it is acceptable and understandable by both parties). For example, an email protocol defines how email addresses are resolved to actual email in-trays; and a telephone protocol defines how telephone numbers are resolved to actual telephones. (The term ‘resolve’ is used in the art to mean, in relation to addresses, interpreting the address to determine the actual location for delivery.)

For a given protocol, each end-point is defined as an address/protocol pair, which inherently means users cannot address an end-point without knowing the protocol and it is not normally possible for a user to communicate with another user using similar but different protocols. In the absence of means for connecting different protocols, two users who wish to communicate must select a protocol they have in common in order to communicate, even though they may already be using the same communication network or interconnected networks. When, as is often the case, the selected protocol requires the use of a particular device, each user needs to have access to that device and be able to use it. This limits the options for communication. Often, no communication can occur, or else the choice of a preferred protocol is compromised by the protocols and devices available.

There are known methods and devices for connecting different protocols. One method is to use an adaptor that connects a specific pair of protocols. Examples of adaptors are shown in U.S. Pat. Nos. 6,020,980 and 6,625,642. These adaptors take those features of the input protocol that can be mapped to a corresponding feature of the output protocol, and provide a mechanism to create a valid pathway between those corresponding features.

One disadvantage of these adaptors is that the adaptor is defined by the two protocols being connected and, because addresses are protocol-specific, the output protocol for the recipient, and the address on that output protocol, must be specified before conversion can occur. In order to ensure the output address/protocol pair is specified before conversion occurs, it has been necessary to either require the initiator of the communication to specifically provide the output address/protocol pair, or in some way to build the information into the recipient's address.

A second disadvantage of these adaptors is that they are tied to a single input protocol and a single output protocol, and therefore cannot guarantee a reply path. A reply path would require the existence of a second adaptor that can map in the reverse direction to the first, and that the original recipient can access this adaptor and knows the address to use for the reply to get through.

As an example of the initiator specifically providing the output address/protocol pair, a Short Message Service (SMS) to email adaptor may require the sender to type in the email address of the recipient as the first part of an SMS message sent to the adaptor, to enable the adaptor to deliver the remainder of the SMS message as an email to the email address. When any SMS is received by such an adaptor, logic processes the SMS, recognizes and interprets the contained email address, and forwards the remainder of the SMS to the interpreted email address. There are a number of disadvantages to this type of solution:
a) the initiator must correctly transcribe the address into each message sent in this way, complicating the process of sending the message, and creating the potential for incorrect transcription of the address;
b) there is the potential for false recognition of data as an address, and the consequent attempt by the adaptor to deliver the remains of the message to a wrong or invalid address;
c) where message length is limited (e.g. SMS) the available message length is reduced;
d) address types not recognized by the address interpreter will not work;
e) the adaptor has a globally visible address and is therefore vulnerable to abuse by malicious parties for purposes such as unsolicited communication (e.g. spam);
f) there is no guaranteed reply path. A corresponding email to SMS adaptor would have to exist, and the original recipient would need to know the correct email address to use to reach the initiating SMS device.

As an example of building the information into the recipient's address, an email to SMS adaptor may require a special email address be allocated to a cellular phone user, so that text sent as an email to this special email address is delivered to the adaptor for processing and forwarding to the recipient's cellular phone in the form of one or more SMS messages. There are a number of disadvantages to this type of solution:
a) the allocated address is not a general-purpose address for this recipient, but an additional public address that has the single function of mapping one address (and hence protocol) to another. Such additional addresses add to the complexity of communication by increasing the number of public addresses for a user;
b) if such an address has not been set up in advance, or is unknown to the initiator, then the initiator cannot communicate with the recipient using the desired protocol;
c) the adaptor has a globally visible address and is therefore vulnerable to abuse by malicious parties for purposes such as unsolicited communication (e.g. spam);
d) there is no guaranteed reply path. A corresponding SMS to email adaptor would have to exist and the recipient would have to have access to it.

One known method to guarantee a reply path is to store information which can be used to automatically route replies, such as a session or connection object, in the adaptor every time a connection is made. However, this solution has limited application as it requires that both initiator and recipient have authority to send data via the same adaptor, for example, through registering in advance. In addition, such a solution adds significant complexity and overhead to the implementation of the adaptor, because the adaptor must be able to recognize when each such session or connection object is no longer needed, so it may be deleted. If the implementation cannot delete unused objects, it will exhaust resources and become inoperable.

As an example of a system that guarantees a reply path, an SMS to instant message adaptor and an instant message to SMS adaptor may be combined to enable SMS users to interact with an instant message system. Such an adaptor could then guarantee reply paths, but only if all initiators and recipients have registered with the adaptor prior to using it. Since there are multiple instant message protocols, users may need to register with multiple adaptors in order to communicate with all their contacts. In addition, SMS users will still need to include the address of the recipient into the body of the SMS (which may be a full address or a shortened code for the address) with the same disadvantages as described above.

### SUMMARY OF CERTAIN INVENTIVE ASPECTS

One aspect of this invention provides a method and apparatus for routing of communications which overcomes or ameliorates at least some of the above problems and other limitations inherent in known methods, or which otherwise provides a more effective communication system for users.

Another aspect of the invention provides a method for determining the routing of a communication, such as a telephonic or data communication, between an initiator and a recipient, comprising storing associations between communication addresses as address mappings, wherein (i) each address mapping (a) is stored such that it is associated with an initiator address from which a communication is initiated and a recipient address to which the communication is addressed, (b) is retrievable using a combination of both the initiator address and the recipient address, and (c) stores an identifier for at least one final address to which the communication is to be delivered, and (ii) an address mapping can be dynamically created in response to an edit request, and determining a final address for a communication from an initiator address addressed to a recipient address from the final address identified by a stored address mapping retrieved using a combination of the initiator address and the recipient address. Once the final address is determined, the communication can be routed to that address.

The final address and the initiator address of an address mapping may have different communication protocols, in which case the protocol of the communication is suitably converted to the protocol of the final address.

In one embodiment of the present invention, an address mapping can be created ‘on the fly’ or dynamically in response to an edit request, e.g. from an initiator. The edit request specifies the initiator address and the final address for the mapping to be created, and the recipient address is either specified by the edit request or is determined automatically using a predetermined algorithm. For example, the recipient address can be determined automatically by allocation from a pool of addresses.

An address mapping may also identify a reply address which is a communication address addressable by the same protocol as the final address. The reply address may be specified by an edit request, or determined automatically using a predetermined algorithm, e.g. allocated from a pool of addresses.

An address can be de-allocated when such allocation is no longer required, so that the address is available for re-allocation from the pool of addresses.

In one embodiment, when an address mapping is created, a corresponding reply mapping is automatically created. This typically involves generating a reply edit request having an initiator address set to the final address of the created address mapping, and a final address set to the initiator address of the created address mapping, and then creating the corresponding reply mapping from the reply edit request.

The reply edit request may comprise a reply address set to the recipient address of the created address mapping.

In one embodiment, a stored address mapping may be modified, e.g. in response to a modify edit request, in which case any corresponding reply mapping is normally modified automatically.

Another aspect of the invention provides apparatus for routing a communication, such as a telephonic or data communication, the apparatus including mapping means adapted to communicate with one or more communication networks, the mapping means having a data store containing associations between communication addresses as address mappings, wherein each address mapping is stored such that it is associated with an initiator address from which a communication is initiated and a recipient address to which the communication is addressed, is retrievable using a combination of both the initiator address and the recipient address, and stores an identifier for at least one final address to which the communication is to be delivered, and search means responsive to a lookup request specifying an initiator address and a recipient address, for searching the data store for an address mapping associated with the specified initiator and recipient addresses, and for identifying a final address from that address mapping if such an address mapping is found.

In one embodiment, the mapping means creates an address mapping in response to an edit request, and stores the created address mapping in the data store.

The apparatus suitably comprises a protocol converter for converting the protocol of the communication if the protocol of the output final address is different from the protocol of the initiator address.

In one embodiment of the invention, associations between communication addresses are stored in the data store as “dynamic address mappings”. As mentioned above, a dynamic address mapping minimally contains a final address, and is associated with an initiator address and a recipient address.

A new dynamic address mapping may be created and stored within the data store in response to one or more requests, typically from a communication initiator. The recipient address to be associated with the dynamic address mapping may be specified in the request, or may be dynamically allocated by the mapping device using a predetermined algorithm.

When a request for a lookup is made to the mapping device, the mapping device identifies zero or one dynamic address mapping within the data store as a function of the initiator address and the recipient address specified in the request. If no dynamic address mapping is identified, the mapping device behaves in a predetermined way, and may generate an error, an empty final address, or a final address computed using a predetermined algorithm. If a dynamic address mapping is identified, the final address specified in the dynamic address mapping is provided by the mapping device as the result of the request. When the protocol of the initiator address is different to that of the final address, the final routing may suitably comprise one or more steps to convert the format of the communication content. Methods for converting data formats are known in the art.

In one embodiment, a recipient address is a forwarding address. When an initiator specifies a recipient address as the destination for a communication, the communication is routed to the final address associated with that initiator address and recipient address.

As described above, many of the problems that prior art protocol adaptors suffer from are involved in address conversion. One embodiment of the present invention separates the task of address conversion from the task of data format conversion, providing an improved system and method for mapping from one address to a different address, and allowing the task of data format conversion to be performed using prior art methods.

In one embodiment, one or more reply addresses may be stored in a dynamic address mapping. If a reply address is contained within the dynamic address mapping, it may be included in the response to a lookup request. If a dynamic address mapping contains more than one reply address, then one may be selected by the mapping device using a predetermined algorithm. In one embodiment, a second dynamic address mapping, known as a reply mapping, is automatically generated to map the selected reply path to the initiator address.

A dynamic address mapping may be associated with multiple initiator addresses and/or multiple recipient addresses. In addition, a dynamic address mapping may contain multiple final addresses. If the identified dynamic address mapping contains multiple final addresses, one is selected by the mapping device using a predetermined algorithm.

The apparatus and method according to at least one embodiment of the invention can be implemented in a communication routing and conversion device, thereby providing dynamic address mapping, in addition to data format conversion and routing, all within a single device.

One embodiment of the present invention provides a method in which an address mapping can be created in response to a request by the initiator, no prior arrangements need to be made by potential recipients for the method to function effectively. This is a significant improvement over prior art in which either potential recipients must arrange for a public address mapping to be created and notify potential initiators of the details, or potential initiators must manually insert a final address into each message body. In addition, the ability to include one or more reply addresses in an address mapping is a significant improvement over prior art in which reply paths are normally only guaranteed by systems that require prior registration by both initiators and recipients.

Furthermore, since the address mappings are identified as a function of initiator address, the address mappings need not be associated with publicly visible addresses. This is a significant improvement over prior art in which address mappings are associated with a public address which causes the complexity of communication to be increased due to the increased number of addresses per user, and which unnecessarily consumes address space (which for some systems is a limited resource, e.g. telephone numbering plans).

Other advantages include:
a) Dynamic address mappings may be temporary and safely deleted or recycled, since all possible users of a dynamic address mapping are known in advance, and therefore the effects of deleting a dynamic address mapping can be predicted and controlled. This contrasts to prior art in which address mappings are public, and therefore the list of possible users is unknown, which means deleting such an address mapping disrupts an unknown number of users, making the system appear unreliable to those users.
b) Because dynamic address mappings can be deleted, resource consumption is kept finite. This contrasts with those prior art systems which allocate an object per session which must employ complex resource management logic, or have limits on the number of connected users, or both.
c) Because dynamic address mappings can only be used in conjunction with a known initiator address, it is difficult for other initiating users to discover or use them, greatly reducing the possibility of abuse such as unsolicited communications and spam.

In order that the invention may be more readily understood and put into practice, one or more embodiments thereof will now be described, by way of example only, with reference to the accompanying drawings.

### BRIEF DESCRIPTION OF DRAWINGS

FIG. 1 is a block diagram of a mapping device in accordance with one embodiment of the present invention, connected to one of two interconnected communication networks which are used by a plurality of communication users.

FIG. 2 is a block diagram of the mapping device of FIG. 1.

FIG. 3 is a flowchart illustrating logic executed by the mapping device of FIGS. 1 and 2.

FIG. 4 is an example of two edit requests, two dynamic address mappings, and a response, which are used in describing the logic of FIG. 3.

### DETAILED DESCRIPTION OF CERTAIN INVENTIVE EMBODIMENTS

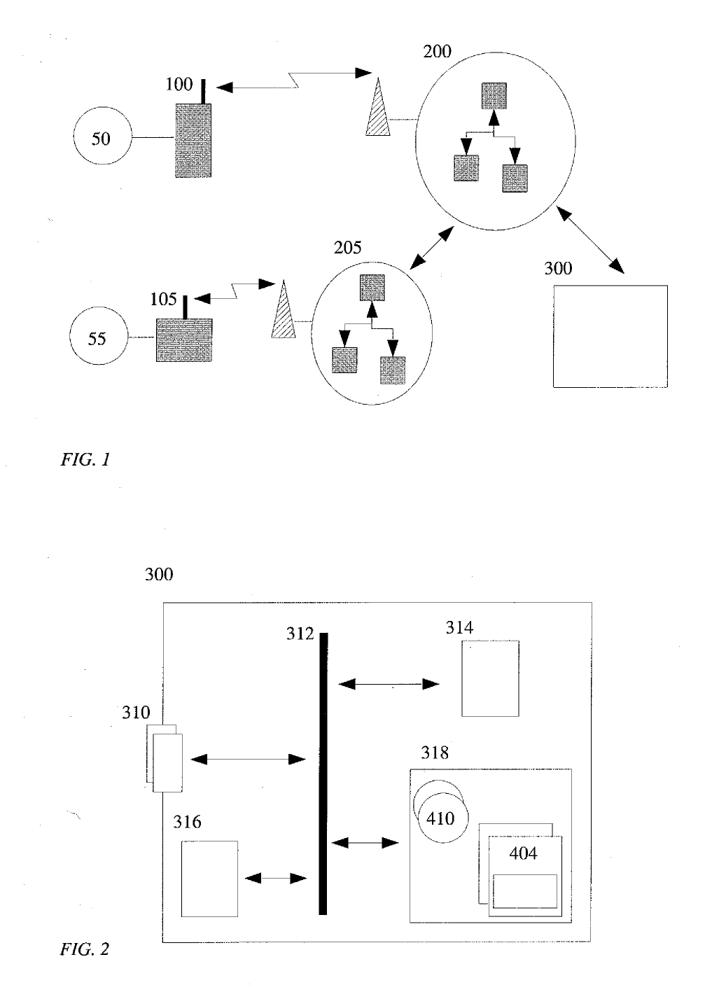

Referring to FIG. 1, users 50 and 55 may each be a person, computer program, an executing piece of code, or any other agent capable of sending and/or receiving information. Users 50 and 55 use communication devices 100 and 105 respectively. Devices 100 and 105 are connected to communication networks 200 and 205 respectively. Device 100 may be a cellular phone with text message capabilities, and network 200 is a public cellular telephone network. Device 105 may be a wireless email client and network 205 is a private data network which is connected to network 200. Networks 200 and 205 may both be connected to further networks (not shown) including the public switched telephone network, and the Internet. Further communication devices (not shown) may be connected to networks 200 and 205, wirelessly or otherwise. However, it will be understood that the invention is applicable to any combination of wireless and non-wireless devices and networks.

Mapping device 300, is connected to network 200. Device 300 may be connected to other networks including, for example, network 205. Data flow between elements is illustrated using lines with arrows.

Network 200 is capable of sending requests to mapping device 300 in response to specific network events. For example, requests to change or manage the data stored in device 300 may be received by network 200 and forwarded to device 300, and responses from device 300 may be forwarded by network 200 to the appropriate device. In addition, network 200 can generate requests that it sends to device 300. For example network 200 may send a request to device 300 for every communication it attempts to route. Requests to device 300 are in one or more predetermined formats compatible with device 300. Different embodiments of the present invention may support different formats. Formats for requests and responses are known in the art, and include IPC (Inter-Process Communication), RPC (Remote Procedure Call), XML-RPC, SOAP (Simple Object Access Protocol), CORBA (Common Object Request Broker Architecture), HTTP (Hyper-Text Transport Protocol), TCAP (Transaction Capabilities Applications Part (of the SS7 protocol)) etc.

Referring to FIG. 2, mapping device 300 includes communication ports 310, data bus 312, processor 314, instruction store 316, and data store 318 which may comprise any suitable memory device. Communication ports 310 are used to connect mapping device 300 to external components such as network 200 and other mapping devices (not shown), and references in this document to device 300 communicating with such external components implicitly refer to using communication ports 310 for such communication. Communication ports are known in the art, and include ethernet ports, USB ports, and serial ports, etc. Communication ports 310 are coupled to an internal data bus 312.

Also connected to internal data bus 312 are microprocessor 314, instruction store 316 and data store 318. Microprocessor 314 executes instructions from instruction store 316 to execute the logic of the mapping device. Microprocessor 314 can read data from and write data to data store 318, such data including parameters used to execute instructions from instruction store 316 and dynamic address mappings including dynamic address mapping 404. Dynamic address mappings are stored in data store 318 in such a way as to be retrievable using predetermined associated lookup criteria. In one embodiment, such lookup criteria include an initiator address and a recipient address, which can be used for lookup either in combination or independently. Methods for retrieving data using lookup criteria are known in the art, and include hashtables, b-trees, indexed files such as ISAM files, databases, etc.

Data store 318 is also used to store one or more address pools 410. Address pools 410 contain communication addresses which are allocated using logic described below. The pools are initialized using administrative functions (not shown), with each pool containing addresses that are compatible with one protocol supported by the mapping device. Typically, each pool is initialized with addresses that resolve to a network that uses that mapping device to process its lookup requests. In the more general case, the addresses resolve to a network which uses a mapping device capable of resolving those addresses. In this context, an address resolves to a network if communications addressed to that address are directed to that network for delivery. In this example, the addresses in the address pools 410 in mapping device 300 resolve to network 200.

In one embodiment, mapping device 300 is implemented as a discrete device, but other embodiments are possible, for example as part of a communication routing and conversion device, thereby providing dynamic address mapping according to one embodiment of the present invention, in addition to data format conversion and routing, in a single device.

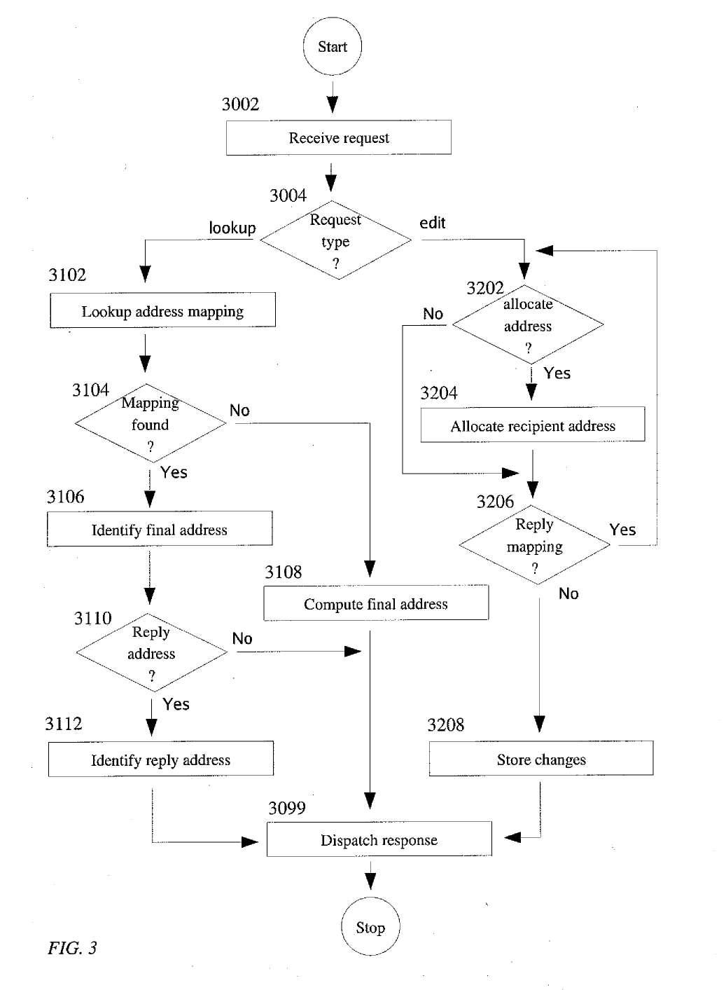

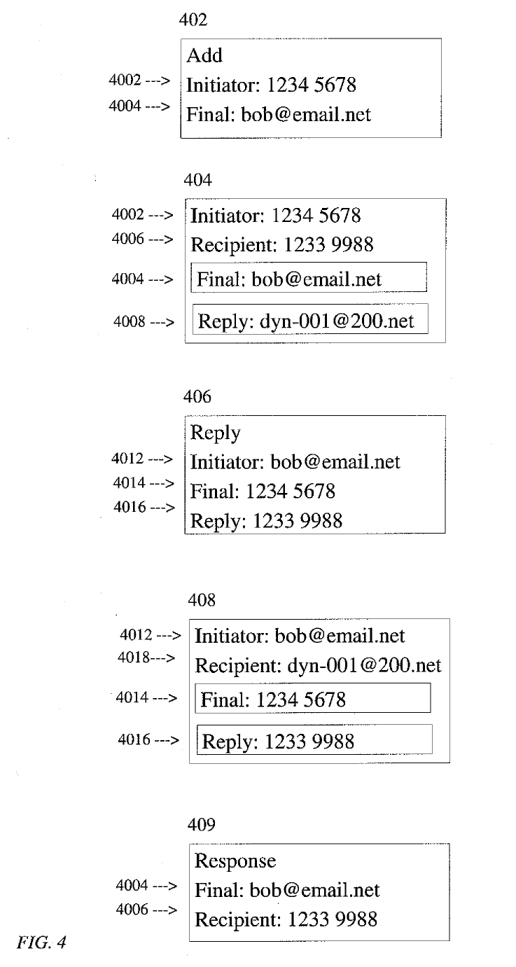

FIG. 3. is a flowchart illustrating logic executed in mapping device 300 in response to requests received by device 300. Requests to create, modify, or delete a new or existing dynamic address mapping are known as edit requests, and are processed according to the specifics of the request. Requests for an address lookup are known as lookup requests, and are processed by attempting to identify a stored dynamic address mapping as a function of the initiator address and the recipient address specified in the request, and determining a final address from the identified dynamic address mapping. Any other requests relate to functions of device 300 which are not necessarily a part of this invention. A final address represents a communication address to which a communication is finally routed; an initiator address represents a communication address from which the communication is initiated; and a recipient address represents an address to which a communication is initially routed. It is not necessary that the values used within device 300 to represent these address be identical to the address itself. An embodiment may choose to use some other unique identifier (e.g. a number or a hashcode) to represent each address. Similarly, network 200 may use some other identifier in place of the actual address, and pass this to device 300 along with, or in place of, an actual communication address. In this document, any reference to a communication address also includes an identifier representing an address. In general, a lookup request must specify the initiator address and the recipient address, whereas an edit request will normally specify the initiator address as well as a final address and/or a recipient address. In one, any errors result in a response being dispatched (at block 3099) that describes the error. Errors include such events as invalid or contradictory information, or required information being missing.

Through the lookup request, one embodiment of the present invention effectively separates the task of address conversion from the task of data format conversion. One embodiment of the present invention can therefore provide an improved method for converting an address in one protocol to an address in a different protocol, whilst leaving the task of data format conversion to be performed using prior art methods.

The logic starts at block 3002 by receiving a request. The logic identifies the request type, the initiator address specified in or by the request, and any additional information that may be specified in or by the request, such as a recipient address and/or a final address.

If (at block 3004) the type of request is a lookup request, the logic proceeds to block 3102 and attempts to identify a dynamic address mapping as a function of the initiator address and the recipient address identified at block 3002.

If (at block 3104) a dynamic address mapping is not identified, the logic proceeds to block 3108 where a final address is computed according to a predetermined algorithm. In one embodiment, the final address is computed to be the same as the recipient address. This enables device 300 to transparently handle requests pertaining to recipient addresses for which no dynamic address mapping has been created. Alternative algorithms are possible, such as generating an error.

If (at block 3104) a dynamic address mapping is identified, then the final address is retrieved (at block 3106) from the identified dynamic address mapping.

If (at block 3110) the identified dynamic address mapping contains a reply address, and a reply address is not contradictory to the request, then the logic proceeds to block 3112, otherwise the logic proceeds to block 3099. In one embodiment, a reply address is contradictory to the request if the protocol of the resulting connection cannot, or does not need to, use a reply address, or if the request specifically prohibits a reply address. Generally, asynchronous protocols such as email are consistent with a reply address, whereas synchronous protocols such as instant message (“chat”) are contradictory.

At block 3112 a reply address is selected from the identified dynamic address mapping using a predetermined algorithm. In one embodiment, the algorithm compares the protocol of the reply address to the protocol of the final address and ensures that the protocol of the final address can initiate communication with the reply address. In one embodiment, if no reply address can be selected, then no error is produced, and the logic proceeds without a reply address. The logic then proceeds to block 3099, dispatches the response to the request and then stops.

If (at block 3004) the request is an edit request, the logic proceeds to block 3202.

If (at block 3202) the request requires a recipient address to be allocated, the logic proceeds to block 3204, otherwise the logic proceeds to block 3206. In one embodiment a request requires a recipient address to be allocated if it requires a new recipient address and the recipient address is not specified in the request.

The logic allocates (at block 3204), using a predetermined algorithm, a recipient address to associate with the dynamic address mapping or reply mapping being edited. In one embodiment, the recipient address is allocated from one of the address pools 410. The allocation is performed using the pool that contains addresses compatible with the initiator address. The logic maintains a record of each allocated address along with the initiator address associated with that allocation. In this way, each pair of initiator address and allocated recipient address is unique, which means that the same recipient address can be allocated multiple times, provided that the initiator address is different for each allocation. To allocate a new recipient address, the logic identifies an address that is currently not associated with the initiator address (i.e., is currently “free” or “unassigned” for this initiator address). If such a free address is identified, then it is used and a record made of this allocation. If no such free address is identified, then the logic treats this as an exception, and behaves in a predetermined way. In one embodiment, the logic generates an error response (not shown), telling the initiator that no recipient address could be allocated. Allocation techniques are known in the art.

If (at block 3206) a reply mapping is required, then the logic generates an edit request corresponding to the current request with final and initiator addresses from the current request reversed, and specifying the newly allocated recipient address as the reply address. The logic then proceeds to block 3202. In one embodiment, a reply mapping is required if the current mapping is not a reply mapping, and the request does not prohibit a reply mapping. This means that in one embodiment, each dynamic address mapping has a corresponding reply mapping generated automatically, unless the original edit request specifically prohibits this. Generating a corresponding reply edit request for each non-reply request causes the generated reply address to be created whenever a dynamic address mapping is created, modified when the dynamic address mapping is modified, and deleted when the dynamic mapping is deleted.

The logic updates (at block 3208) the dynamic address mapping and the reply mapping, if applicable, and stores the changes into data store 318. If the request has caused one or more recipient addresses to become “free”, then the logic updates the allocation records in data store 318 to reflect this. Recipient addresses may become free as a result of deleting, or changing the recipient address associated with, a dynamic address mapping or a reply mapping, in accordance with known allocation techniques.

The logic then proceeds to block 3099, dispatches the response, and then stops.

Referring also to FIG. 4, an edit request 402 contains the initiator address 4002 and final address 4004. Dynamic address mapping 404 is associated with initiator address 4002 and recipient address 4006, and contains final address 4004 and reply address 4008.

In an example application of the invention, user 50 wishes to use communication device 100 to communicate with user 55. User 50 is therefore the initiator, and user 55 the recipient. However, user 55 only has communication device 105, which cannot be addressed by any protocol available on device 100. In this example, device 100 is a cellular phone with SMS text abilities, and device 105 is a wireless email device. Whilst SMS and email are both text protocols, and methods for the conversion of the message content from one text protocol to another are known in the art, the addressing schemes are incompatible. The SMS protocol can only address telephone numbers, and the email protocol can only understand email addresses. This means that user 50 cannot directly address an SMS message to device 105.

In this example, initiator address 4002 is the telephone number “1234 5678” which is of a different format to final address 4004 which is the email address “bob@email.net”. Because the formats of these two addresses are different to each other, these addresses are incompatible. In contrast, recipient address 4006 is of the same format as initiator address 4002, and is therefore compatible. This means that a device associated with initiator address 4002 and compatible only with telephone numbers can address recipient address 4006, but not final address 4004. Similarly, because final address 4004 is incompatible with initiator address 4002, no reply message can be sent from final address 4004 to initiator address 4002. However, reply address 4008 is of the same format as final address 4004, and is therefore compatible with final address 4004.

Edit request 406 is a generated request that causes reply address mapping 408 to be created.

Reply address mapping 408 is associated with initiator address 4012 and recipient address 4018, and contains final address 4014 and reply address 4016.

Response 409 is a response from mapping device 300, and contains final address 4004, and recipient address 4006.

As described previously, mapping device 300 is able to create a new address mapping in response to an edit request. User 50 therefore sends edit request 402 to device 300, including the desired final address 4004 in the request. In this example, user 50 sends the request as an SMS to a phone number provided on network 200 for such requests. Other methods are also possible such as use of a web portal connected to device 300, etc. The format of request 402 is determined by the implementation of device 300 and any logic used to connect device 300 to network 200. For example, the request may need to be in a specific format so that device 300 can correctly identify the contained information. Alternatively, device 300 or network 200 may contain logic to extract information from free-form text, meaning that request 402 could be free-form text. Methods for extracting information from free-form text are known in the art. An example of a strictly formatted request is “Add: Final: bob@email.net”, and an example of a free-form request is “Give me an SMS address to reach bob@email.net”.

As described previously with reference to FIG. 3, device 300 responds to request 402 by creating dynamic address mapping 404. Device 300 allocates recipient address 4006 from one of the address pools 410, and associates dynamic address mapping 404 with initiator address 4002 and recipient address 4006. Device 300 stores the supplied final address 4004 into dynamic address mapping 404. Since dynamic address mapping 404 is not a reply mapping, and request 402 does not prohibit a reply mapping, device 300 creates a reply address mapping by generating edit request 406.

Generated edit request 406 contains initiator address 4012 and final address 4014, which have the same values as final address 4004 and initiator address 4002 respectively. This reversal of the two addresses defines a reply path. Request 406 also includes reply address 4016 which has the same value as recipient address 4006. Including reply address 4016 in request 406 ensures the logic can generate reply mapping 408 to correctly refer to dynamic address mapping 404 as its reply path, thereby ensuring symmetric reply paths. The inclusion of reply address 4016 can also be used by the logic to help determine whether request 406 is a reply request.

Mapping device 300 then allocates a recipient address which is compatible with initiator address 4012 for reply mapping 408, and stores dynamic address mapping 404 and reply mapping 408 in data store 318.

Finally, mapping device 300 dispatches response 409 containing recipient address 4006. This response is delivered to user 50, in this example as an SMS via network 200 to device 100. The response may be generated by device 300 in human-readable form (by logic not shown), or may be converted to human-readable form by other logic (not shown). An example response is “SMS number 1233 9988 can now be used from 1234 5678 to reach bob@email.net (or just reply to this message)”. Techniques for generating human-readable forms of data are known in the art.

User 50 now initiates the desired communication from device 100 to device 105 by addressing the communication to the allocated recipient address 4006, which in this example means sending an SMS to phone number “1233 9988”.

In this example, network 200 is configured to send a lookup request to device 300 for each communication it attempts to route. According to the logic flowchart of FIG. 3, mapping device 300 responds to the lookup request by attempting to identify a dynamic address mapping associated with the initiator address 4002 and recipient address 4006. In this example, dynamic address mapping 404 is identified. Device 300 then retrieves the final address 4004 from dynamic address mapping 404. Device 300 then selects reply address 4008 and dispatches a response (not shown) containing final address 4004 and reply address 4008 to network 200. Network 200 can now deliver the communication using final address 4004 as the destination address, and reply address 4008 as the reply address, ultimately causing the communication to be delivered to device 105 via network 205. In this example, network 200 converts the format of the communication content from SMS format to email format. Methods for this are known in the art.

If user 55 replies to the message, the email client on device 105 will address the reply to reply address 4008. In this example, reply address 4008 resolves to network 200, and therefore network 205 forwards the message to network 200 for delivery. Network 200 will again send a lookup request (not shown) to mapping device 300 which will identify reply mapping 408, and return final address 4014 and reply address 4016 in a response (not shown) to network 200, which will deliver the reply to device 100. Network 200 will have to convert the content of the message from email to SMS.

It will be apparent that user 50 can also reply to a reply from user 55, without having to manually address the reply to recipient address 4006. In this example, network 200 sets the “from” address to reply address 4016 for each SMS delivered using reply mapping 408. Therefore, when user 50 replies to such an SMS message, the message is automatically routed to reply address 4016, which has the same value as recipient address 4006. This causes the message to be automatically routed using address mapping 404.

One embodiment of the present invention enables communication to be completed between two devices with incompatible addresses, without the recipient having had to make prior arrangements to enable this, and without requiring the initiator to include the recipient's address in each message. This contrasts to prior art in which the recipient has to make prior arrangements, or the initiator has to include the recipient's final address in each communication. In addition, symmetric reply paths have been provided, ensuring that the communication is two-way. This contrasts to prior art in which reply paths can only be guaranteed by systems that typically require prior registration by both initiator and recipient.

One embodiment of the present invention allows a new dynamic address mapping to be created and used as soon as the need arises. In addition, dynamic address mappings may persist, meaning subsequent communication can occur with no further preparation. That is, user 50 can initiate further communication from device 100 to recipient address 4006 without having to create a further dynamic address mapping.

In addition, because the size of the address pools in each mapping device can be preset, the resources consumed by each dynamic mapping device are predefined and finite. This contrasts to those prior art techniques which allocate a new object for each connection, and which therefore must arbitrarily limit the number of simultaneous connections, and implement resource reclamation (e.g. garbage collection) to avoid exhausting resources.

In one embodiment, mapping device 300 can also communicate with other mapping devices. One benefit of this is to distribute the load of recipient address allocation and lookup request processing over multiple devices, instead of centralizing them in a single device. For example, mapping device 300 could request a second mapping device (not shown) connected to network 205 to create reply mapping 408. In this case, the reply from user 55 would cause network 205 to request the address mapping lookup and perform message content format conversion.

In one embodiment, a dynamic address mapping may be simultaneously associated with multiple recipient addresses and/or multiple initiator addresses, and/or include multiple final addresses and/or multiple reply addresses. In each case, this provides the same effect as having multiple dynamic addresses mappings, each associated with a different combination of addresses. It will be readily apparent that implementing this as a single dynamic address mapping consolidates the information, providing benefits such as reduced storage overheads, simplified logic due to simplified lookup, and the elimination of the need to maintain multiple copies of a dynamic address mapping. However, in most other respects this represents primarily a different implementation strategy.

In the case that the logic identifies a dynamic address mapping which contains multiple final addresses, one final address is selected using a predetermined algorithm.

In the case that the logic identifies a dynamic address mapping which contains multiple reply addresses, and a reply address is consistent with the request, one reply address is selected using a predetermined algorithm

Associating a dynamic address mapping with multiple initiator addresses and/or recipient addresses allows for the fact that a single user (initiator or recipient) may be associated with multiple addresses (e.g., email and instant message addresses for a single person). In the case of multiple initiator addresses, it also allows a single mapping to be shared between a controlled number of initiators without requiring the dynamic address mapping to be made public. In addition, if such a dynamic address mapping contains multiple final or reply addresses, then the predetermined algorithm used to select one final address and/or one reply address from the multiple possible addresses may include information about the specific initiator address and/or recipient address used for the lookup. For example, the protocol associated with the initiator address and/or recipient address could be used to identify the best matching final address or reply address.

In an alternative embodiment, a request could cause the logic to identify multiple dynamic address mappings. This could be because multiple dynamic address mappings are associated with the one initiator/recipient pair, or the lookup logic used does not use the initiator and recipient address in combination to perform the lookup, but performs the lookup in stages instead. In this case, one dynamic address mapping would be selected by the logic using a predetermined algorithm. For example, the algorithm could consider the type of communication being attempted, the final addresses contained in each identified dynamic address mapping, etc.

Because a recipient address is always associated with an address mapping in conjunction with an initiator address, multiple dynamic address mappings may be associated with the same recipient address simultaneously. This significantly reduces the additional consumption of addresses on a given protocol. For example, a telephone company could allocate 100 telephone numbers for dynamic address mappings. This would mean that every subscriber of this telephone company could have 100 different dynamic address mappings, with each subscriber associating each of those 100 allocated numbers with different final addresses and/or initiator addresses. To enable this, the telephone company would configure a pool of predetermined addresses in the appropriate mapping device (e.g., device 300) to contain this set of 100 numbers.

It will be further apparent that because a dynamic address mapping is private to a known list of initiators, all possible users of a dynamic address mapping are known. This means that dynamic address mappings may be temporary and may be deleted or recycled in such a way that does not cause disruption to users. For example, users may be notified of mapping deletion, or deleted mappings may be automatically removed from users' address books, etc. This contrasts to prior art in which address mappings are public, and therefore the list of possible users is unknown. This means that the effects of deleting a public address mapping cannot be predicted. If a public address mapping is deleted, it disappears without warning. Such events make the system less predictable, and hence less reliable from a user's perspective.

Because allocated recipient addresses can be allocated from a fixed pool, can be simultaneously associated with multiple initiator addresses and final addresses, and can be safely deleted or modified, embodiments of the present invention can be configured to consume no more than a set amount of resources. This contrasts with those prior art systems that allocate resources per connection and must therefore arbitrarily restrict the number of simultaneous connections, and employ complex resource management logic.

It will also be readily apparent that because they are always accessed through an initiator address, dynamic address mappings are far less open to use or abuse by other initiating parties, for example for the purposes of creating unsolicited communication such as SPAM. This is because a dynamic address mapping can only be accessed by the user of an initiator address that has been associated with the address mapping.

The forgoing describes only some embodiments of the invention, and modifications and additions which are obvious to those skilled in the art may be utilized without departing from the scope of the present invention.

Although the present invention has been described with particular reference to situations in which the protocol of the initiator and the protocol of the recipient differ, it will be readily understood that the present invention could be used to provide dynamic address mapping between addresses on the same, or compatible protocols. For example, a user (potential initiator or recipient) may create a dynamic address mapping from one telephone number to another, thereby creating an alias for the final address. Such aliases may be used as temporary numbers that can be provided to specific users, and then disabled once the need for them has passed; or as an alternative number that is associated with number-specific behavior or processing, such as that provided by an intelligent network (IN) system of a telephone network.

What is claimed is:

1. A method of determining the routing of a communication between an initiator and a recipient, comprising:
storing associations between communication addresses as address mappings, wherein
(i) each address mapping
(a) is stored such that it is associated with an initiator address from which a communication is initiated and a recipient address to which the communication is addressed,
(b) is retrievable using a combination of both the initiator address and the recipient address, and
(c) stores an identifier for at least one final address to which the communication is to be delivered; and
(ii) an address mapping can be dynamically created in response to an edit request; and
determining a final address for a communication from an initiator address addressed to a recipient address, from the final address identified by a stored address mapping retrieved using a combination of the initiator address and the recipient address.

2. The method of claim 1, wherein the determining comprises:
receiving a lookup request specifying the initiator and recipient addresses;
searching for an address mapping associated with the initiator and recipient addresses specified by the request; and
providing the final address identified by an address mapping associated with the initiator and recipient addresses specified by the request, if such an address mapping is located.

3. The method of claim 1, wherein the edit request specifies the initiator address and the final address for the mapping to be created, and
the recipient address is specified by the edit request or is determined automatically using a predetermined algorithm.

4. The method of claim 3, wherein the recipient address is determined automatically by allocation from a pool of addresses.

5. The method of claim 4, wherein the recipient address is de-allocated when such allocation is no longer required, so that the address is available for re-allocation from the pool of addresses.

6. The method of claim 1, wherein at least one address mapping further identifies a reply address, the reply address being a communication address which is addressable by the same protocol as the final address.

7. The method of claim 1, wherein at least one address mapping created in response to an edit request identifies a reply address which is addressable by the same protocol as the final address, and wherein the reply address is specified by the edit request, or is determined automatically using a predetermined algorithm.

8. The method of claim 7, wherein the reply address is determined automatically by allocation from a pool of addresses.

9. The method of claim 8, wherein the reply address is de-allocated when such allocation is no longer required, so that the reply address is available for re-allocation from the pool of addresses.

10. The method of claim 1, wherein when an address mapping is created, a corresponding reply mapping is automatically created, wherein the initiator address of the reply mapping is set to the final address of the created address mapping, and the recipient address of the reply mapping is set to a reply address of the created address mapping or is determined automatically using a predetermined algorithm.

11. The method of claim 10, further comprising setting the final address of the corresponding reply mapping to the initiator address of the created address mapping.

12. The method of claim 11, wherein the creation of a corresponding reply mapping comprises generating a reply edit request and creating the corresponding reply mapping from the reply edit request.

13. The method of claim 12, wherein the generated reply edit request comprises a reply address set to the recipient address of the created address mapping.

14. The method of claim 1, further comprising modifying an address mapping and/or a corresponding reply mapping in response to a modify edit request.

15. A method of claim 14, wherein modifying a corresponding reply mapping comprises
generating a reply modify edit request having an initiator address set to the final address of the modified address mapping, and a final address set to the initiator address of the modified address mapping; and
modifying the corresponding reply mapping in response to the reply modify edit request.

16. The method of claim 15, wherein the reply modify edit request comprises a reply address set to the recipient address of the modified address mapping.

17. The method of claim 1, further comprising associating a single address mapping with multiple initiator addresses and/or multiple recipient addresses.

18. The method of claim 1, wherein an address mapping identifies multiple final addresses and/or multiple reply addresses, and
a single final address is selected from the multiple final addresses using a predetermined algorithm, and/or
a single reply address is selected from the multiple reply addresses using a predetermined algorithm.

19. The method of claim 1, wherein the final address and the initiator address of an address mapping have different communication protocols, and/or the final address and the initiator address of a reply mapping have different communication protocols.

20. The method of claim 1, wherein the edit request is from an initiator address.

21. A method of routing a communication, comprising:
storing associations between communication addresses as address mappings, wherein each address mapping
(i) is stored such that it is associated with an initiator address from which a communication is initiated and a recipient address to which the communication is addressed and which is addressable by the same communication protocol as the initiator address,
(ii) is retrievable using a combination of both the initiator address and the recipient address, and
(iii) stores an identifier for at least one final address to which the communication is to be delivered, and
wherein at least one address mapping can be dynamically created in response to an edit request;
determining a final address for a communication from an initiator address addressed to a recipient address, from the final address identified by a stored address mapping retrieved using a combination of the initiator and recipient addresses; and
routing the communication from the initiator address to the final address.

22. The method of claim 21, wherein when an address mapping is created in response to an edit request, the edit request specifies both the final address and the initiator address of the address mapping, and the recipient address of the address mapping is specified in the edit request or is determined automatically using a predetermined algorithm.

23. The method of claim 21, wherein at least one address mapping further identifies a reply address, the reply address being a communication address which is addressable by the same protocol as the final address.

24. The method of claim 21, further comprising automatically storing an association between a final address and both an initiator address and a recipient address as reply mapping, wherein the initiator address of the reply mapping corresponds to the final address of the address mapping, and the recipient address of the reply mapping is a communication address which is addressable by the same protocol as the initiator address of the reply mapping.

25. The method of claim 24, wherein the final address of the reply mapping is set to the initiator address of the created address mapping.

26. The method of claim 24, wherein the reply mapping specifies a reply address which is a communication address which is addressable by the same protocol as the final address of the reply mapping.

27. Apparatus for routing a communication, the apparatus comprising
mapping means adapted to communicate with one or more communication networks, the mapping means having a data store containing associations between communication addresses as address mappings, wherein each address mapping
(a) is stored such that it is associated with an initiator address from which a communication is initiated and a recipient address to which the communication is addressed,
(b) is retrievable using a combination of both the initiator address and the recipient address, and
(c) stores an identifier for at least one final address to which the communication is to be delivered; and
search means responsive to a lookup request specifying a combination of an initiator address and a recipient address, for searching the data store for an address mapping associated with the specified initiator and recipient addresses, and for identifying a final address from that address mapping if such an address mapping is found.

28. The apparatus of claim 27, wherein the mapping means comprises means for creating an address mapping in the data store in response to an edit request.

29. The apparatus of claim 27, further comprising a protocol converter for converting the protocol of the communication if the protocol of the output final address is different from the protocol of the initiator address.
